(19) United States
(12) Patent Application Publication
(10) Pub. No.: US 2022/0304308 A1
(43) Pub. Date: Sep. 29, 2022

(54) METHOD FOR CONTROLLING GROWTH OF GLYPHOSATE-TOLERANT PLANTS

(71) Applicant: JIANGSU ROTAM CHEMISTRY CO., LTD., Kunshan, Jiangsu (CN)

(72) Inventor: James Timothy Bristow, Chai Wan (HK)

(21) Appl. No.: 17/638,989

(22) PCT Filed: Nov. 21, 2019
(86) PCT No.: PCT/CN2019/119852

§ 371 Date: Feb. 28, 2022

(30) Foreign Application Priority Data
Aug. 30, 2019 (GB) 1912456.9

(51) Int. Cl. A01N 57/20; A01N 47/36

(52) U.S. Cl. CPC A01N 57/20; A01N 47/36

(57) ABSTRACT

A method for controlling the growth of unwanted plants in crop plants at a locus using a sulphonylurea herbicide, wherein the sulfonylurea herbicide exhibits phytotoxicity to the crop plants is provided, The method comprises:
a) applying a sulphonylurea herbicide to the locus; and
b) planting the crop plants at the locus a time N days after the application of the sulphonylurea herbicide in step a).

### CROSS REFERENCE TO RELATED APPLICATIONS

This application is a national stage of International Application No. PCT/CN2019/119852, filed Nov. 21, 2019, which claims the priority of UK Patent Application No. GB1912456.9, filed on Aug. 30, 2019, and titled with “METHOD FOR CONTROLLING GROWTH OF GLYPHOSATE-TOLERANT PLANTS”, and the disclosures of which are hereby incorporated by reference.

### BACKGROUND

### 1. Technical Field

The present invention relates to a method for the control of the growth of plants exhibiting tolerance to the herbicide glyphosate.

### 2. Related Art

The protection of crops from undesirable vegetation, which inhibits crop growth, is a constantly recurring problem in agriculture. Weeds may compete with crop plants for the essential components required for healthy growth and development of the crop plants, in turn inhibiting the growth and development of the crop plants. In addition, weeds may produce toxic or irritant chemicals, which again can inhibit the healthy growth of the crop plants. In addition, such weeds may also pose a danger to animals or humans. As a result, the ability to control the growth of such undesirable plants is advantageous.

To solve this problem, researchers are trying to develop an extensive range of chemicals and chemical formulations effective in the control of such undesirable growth. Chemical herbicides of many types have been disclosed in the literature and a large number are in commercial use.

However, one problem that is now emerging through continued use of chemical herbicides is the development of plants exhibiting resistance or tolerance to one or more herbicidally active ingredients. One such herbicidally active ingredient is glyphosate.

Glyphosate (N-(phosphonomethyl)glycine) is an organophosphorous herbicide having the following structure:

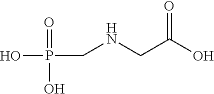

Glyphosate has been employed commercially in the control of a range of unwanted plant growth for a considerable length of time.

It has now been found that an increasing number of plants are developing resistance or tolerance to glyphosate, in turn reducing the effectiveness of glyphosate in controlling unwanted plant growth. In particular, resistance to glyphosate has been identified in sourgrass (Digitaria insularis). Reference in this respect is made to de Carvalho L B, “Pool of resistance mechanisms to glyphosate in Digitaria insularis”, J Agric Food Chem., 2012, pages 615 to 622.

Sourgrass (Digitaria insularis) is a persistant problem when it grows in crops, in particular soybean crops. As a result of its increased resistance to glyphosate, the control of sourgrass in soybean crops is becoming increasingly difficult.

There is therefore a growing need to provide a technique which allows glyphosate to be effective in the control of a range of unwanted plants, in particular plants that are exhibiting increased resistance or tolerance to glyphosate. In particular, there is a need for an improved technique for the control of glyphosate-resistant plants, such as sourgrass, in crops of soybean.

It has been found that sulphonylureas, such as nicosulfuron, are effective in the control of sourgrass, including sourgrass that has developed resistance to glyphosate.

Nicosulfuron is a sulphonylurea exhibiting herbicidal activity. Nicosulfuron has the IUPAC name 2-(4,6-dimethoxypyrimidin-2-ylcarbamoylsulfamoyl)-N,N-dimethylnicotinamide or the name 1-(4,6-dimethoxypyrimidin-2-yl)-3-(3-dimethylcarbamoyl-2-pyridylsulfonyl)urea). Nicosulfuron has the following chemical structure:

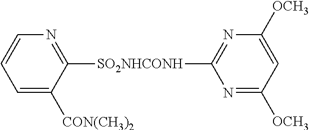

Nicosulfuron is commercially available and is provided in a range of herbicidal compositions. Nicosulfuron is a branched chain amino acid synthesis (ALS) inhibitor and acts by inhibiting biosynthesis of the essential amino acids valine and isoleucine. As a result, cell division of the plant is interrupted and plant growth is stopped. ALS is found in plants but not in animals. Therefore, triazinylsulfonylurea herbicides, such as nicosulfuron, can provide good herbicidal activity with low use rates and a low toxicity to animals.

However, a problem arising from the use of sulphonylureas, such as nicosulfuron, is their phytotoxicity to a range of crop plants, including soybean. Therefore, employing sulphonylureas to control weeds, such as sourgrass, including weeds that exhibit resistance to glyphosate, in crops where the sulphonylurea is phytotoxic, such as soybean, is a problem.

“Phytotoxicity” in the context of the present invention relates to any effect of the herbicide that hinders the ordinary development of a crop plant. Phytotoxic effects of the herbicide may reduce the growth of a crop plant and may even cause plant death.

### SUMMARY

There has now been found a treatment regime that allows sulphonylureas, such as nicosulfuron, to be employed to control unwanted plant growth in crops in which the sulphonylurea is phytotoxic. The treatment regime finds particular use in the control of unwanted plants, such as sourgrass in crops, such as soybean, especially the control of unwanted plants, such as sourgrass, that have strains exhibiting resistance to glyphosate.

In a first aspect, the present invention provides a method for controlling the growth of unwanted plants in crop plants at a locus using a sulphonylurea herbicide, wherein the sulfonylurea herbicide exhibits phytotoxicity to the crop plants, the method comprising:

a) applying a sulphonylurea herbicide to the locus; and

b) planting the crop plants at the locus a time N days after the application of the sulphonylurea herbicide in step a).

### DETAILED DESCRIPTION OF EXAMPLE EMBODIMENTS

The method of the present invention is for the control of the growth of unwanted plants in crop plants. The method employs one or more herbicidally active sulphonylureas. The crop plants are not resistant to the sulphonylurea compounds being applied and at least one of the sulphonylureas is phytotoxic to the crop plants.

The method may employ any suitable herbicidally active sulphonylurea compounds. Suitable sulphonylureas are known in the art and are available commercially, including pyrimidinylsulphonylureas and triazinylsulphonylureas.

Suitable pyrimidinylsulphonylurea herbicides are known in the art and include compounds such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron and zuomihuanglong.

Suitable triazinylsulphonylurea herbicides are also known in the art and include chlorsulfuron, cinosulfuron, ethametsulfuron, iodosulfuron, iofensulfuron, metsulfuron, prosulfuron, thifensulfuron, triasulfuron, tribenuron, triflusulfuron and tritosulfuron.

Pyrimidinylsulphonylurea herbicides are particularly preferred for use in the present invention. Nicosulfuron is a particularly preferred pyrimidinylsulphonylurea.

The sulphonylurea herbicides may be employed in their free acid form. Alternatively, the sulphonylurea herbicides may be employed in the form of salts of the free acid, for example as esters, especially the C₁ to C₄ alkyl esters, such as methyl esters.

A particularly preferred sulphonylurea is nicosulfuron.

The present invention may employ a single sulphonylurea herbicide. Alternatively, two or more sulphonylurea herbicides may be employed. In one embodiment, a combination of nicosulfuron and chlorimuron is employed.

As noted above, the method is used to control the growth of unwanted plants in crop plants, wherein the crop plants are susceptible to damage by treatment with a sulphonylurea herbicide. Crop plants for which sulphonylurea herbicides are phytotoxic are known in the art. For example, Churgett, J. D., et al. ‘Crop Sensitivity to Residues of Three Sulphonylurea Herbicides in a Soil-Free System’, Eleventh Australian Weeds Conference Proceedings, pages 59 to 61, reports the results of a study of the effects of sulphonylurea herbicides on barley, canola, chickpea and wheat plants.

Crop plants for which the method is advantageous include beet plants, for example sugar beet; cereals, such as barley, sorghum, wheat and corn, fibrous plants, for example cotton; leguminous plants, such as soybean, mungbean and chickpea; and oil plants, such as sunflower, oil seed rape, canola and mustard.

The method is particularly advantageous when employed to control the growth of unwanted plants in soybean crops and corn crops.

The method of the present invention finds particular use in the control of unwanted plants in crop plants which are damaged by the sulphonylurea herbicide, in particular unwanted plants that exhibit tolerance or resistance to glyphosate. Examples of plants with strains exhibiting glyphosate resistance that may be controlled in this manner include Smooth pigweed (Amaranthus hybridus), Palmer amaranth (Amaranthus palmeri), Spiny amaranth (Amaranthus spinosus), Tall waterhemp (Amaranthus tuberculatus), Common ragweed (Ambrosia artemisiifolia), Giant ragweed (Ambrosia trifida), Hairy beggarticks (Bidens pilosa), Greater beggarticks (Bidens subalternans), Sweet summer grass (Brachiaria eruciformis), Birdsrape mustard (Brassica rapa), Rescuegrass (Bromus catharticus), Ripgut brome (Bromus diandrus), Red brome (Bromus rubens). Tall windmill grass (Chloris elata), Windmill grass (Chloris truncate), Feather fingergrass (Chloris virgate), Hairy fleabane (Conyza bonariensis), Horseweed (Conyza canadensis), Sumatran fleabane (Conyza sumatrensis), Gramilla mansa (Cynodon hirsutus), Sourgrass (Digitaria insularis), Junglerice (Echinochloa colonal), Goosegrass (Eleusine indica), Woody borreria (Hedyotis verticillata), Common sunflower (Helianthus annuus), Smooth barley (Hordeum murinum), Kochia (Kochia scoparia), Willow-leaved lettuce (Lactuca saligna), Prickly lettuce (Lactuca serriola), Tropical sprangletop (Juddsgrass) (Leptochloa virgate), Perennial ryegrass (Lohum perenne), Italian ryegrass (Lohum perenne). Rigid ryegrass (Lolium rigidum), Ragweed parthenium (Parthentum hysterophorus), Arrocillo (Paspalum paniculatum), Buckhom plantain (Plantago lanceolata), Annual bluegrass (Poa annua), Wild radish (Raphanus raphanistrum), Russian thistle (Salsola tragus), Annual sowthistle (Sonchus oleraceus), Johnsongrass (Sorghum halepense), Coat buttons (Tridax procumbens), and Liverseedgrass (Urochloa panicoides).

The present invention is of particular use in the control of glyphosate-resistant sourgrass (Digitaria insularis) in a range of crops.

In step a) of the method, the sulphonylurea is applied to the locus. The sulphonylurea is applied to the locus before the crop plants are planted or sown. As discussed in more detail below, the crop plants are planted a time N days after the treatment of the locus with the sulphonylurea has finished.

The sulphonylurea may be applied to the locus at any suitable rate that is effective in the control of the unwanted plant growth. The sulphonylurea may be applied to the locus at a rate of at least 5 grams active ingredient per hectare (g a.i./ha), preferably a rate of at least 10 g a.i./ha, more preferably at least 20 g a.i./ha, still more preferably at least 30 g a.i./ha, more preferably still at least 40 g a.i./ha, especially at least 45 g a.i./ha, in particular at least 50 g a.i./ha. The sulphonylurea may be applied to the locus at a rate of up to 150 g a.i./ha, preferably a rate of up to 130 g a.i./ha, more preferably up to 120 g a.i/ha, still more preferably up to 110 g a.i./ha, more preferably still at least 100 g a.i./ha, especially up to 90 g a.i./ha, in particular up to 80 g a.i./ha. A rate of up to 75 g a.i./ha is advantageous for many embodiments. The sulphonylurea may be applied to the locus at a rate in the range of from 5 to 150 g a.i./ha, preferably from 10 to 130 g a.i./ha, more preferably from 20 to 120 g a.i./ha, still more preferably from 30 to 110 g a.i./ha, more preferably still from 35 to 100 g a.i./ha, especially from 40 to 90 g a.i./ha, in particular from 45 to 80 g a.i./ha. An application rate of from 50 to 75 g a.i./ha is particularly advantageous for many embodiments, with a rate of from 60 to 70 g a.i./ha particularly effective in a number of crops.

The volume of sulphonylurea formulation applied to the locus will depend upon the concentration of the sulphonylurea active ingredient in the formulation. Formulations with a higher concentration of sulphonylurea are applied to the locus at lower volumetric rates than more dilute formulations. The formulations may be diluted with water before being applied to the locus, as will be known to the skilled person.

The sulphonylurea formulation is preferably applied to the locus at a volumetric rate of at least 30 litres per hectare (L/ha), more preferably at least 40 L/ha, still more preferably at least 50 L/ha, more preferably still at least 60 L/ha, especially at least 70 L/ha. The sulphonylurea formulation is preferably applied to the locus at a volumetric rate of up to 450 L/ha, more preferably no greater than 400 L/ha, still more preferably no greater than 350 L/ha, more preferably still no greater than 300 L/ha, especially up to 250 L/ha, in particular up to 200 L/ha. The sulphonylurea formulation may be applied to the locus at a volumetric rate of from 30 to 450 L/ha, preferably from 40 to 400 L/ha, more preferably from 50 to 350 L/ha, still more preferably from 60 to 300 L/ha. A volumetric application rate of from 70 to 200 L/ha is especially advantageous.

The locus may be subjected to a single treatment with the sulphonylurea. Alternatively, the locus may be subjected to two or more applications of sulphonylurea, for example three or more applications. In one preferred embodiment, a single application of the sulphonylurea is employed.

In one embodiment, the locus is treated to a burndown treatment during the N days between the end of the application of the sulphonylurea to the locus and the planting of the crop plants at the locus.

Any suitable burndown herbicide may be applied to the locus. Glyphosate is one preferred herbicide for use in the burndown treatment.

The treatment of the locus with the sulphonylurea may be determined by the growth stage of the unwanted plants being targeted for control. In one preferred embodiment, the locus is treated with the sulphonylurea when the unwanted plants are at a vegetative stage of growth.

As noted above, the crop plants are planted at the locus N days after treatment of the locus with the sulphonylurea has ended. The time N days is a sufficient period of time for the sulphonylurea to be effective in controlling the growth of the target unwanted plants, in particular to limit or prevent the growth of the target plants, especially to kill the target plants. It has been found that the time N days may be selected such that effective control of the target unwanted plants may be achieved, but after which the crops may be planted or sown at the locus, without the crop plants being adversely affected by the sulphonylurea herbicide. By following the treatment and planting regime of the present invention, effective control of the unwanted plants, in particular the glyphosate resistant plants, may be obtained, without excessive or undue delay of the planting or sowing of the crop plants.

The time period of N days between the completion of the application of the sulphonylurea to the locus and the planting or sowing of the crop plants various according to various factors. For example, the time period of N days may vary according to the prevailing atmospheric or ambient conditions at the locus, including temperature and relative humidity. Other factors that may affect the time period of N days include the application rate of the sulphonylurea herbicide and the volume of the sulphonylurea formulation applied. Still further, the time period N days may vary according to the location of the locus and the time of year of the treatment of the locus with the sulphonylurea, which determine the hours of sunlight at the locus during treatment.

With respect to the atmospheric or ambient conditions prevailing at the locus at the time of treatment, it is preferred that the locus is treated with the sulphonylurea at an ambient temperature of at least 280 K, more preferably at least 285 K, still more preferably at least 290 K. The ambient temperature at the locus is preferably no greater than 315 K, more preferably no greater than 310 K. An ambient temperature of from 290 to 310 K is particularly preferred for treatment of the locus with the sulphonylurea.

With respect to the atmospheric or ambient relative humidity prevailing at the locus at the time of treatment, it is preferred that the locus is treated with the sulphonylurea when the prevailing conditions at the locus are humid. In particular, it is preferred that the locus is treated with the sulphonylurea at a relative humidity of at least 15%, more preferably at least 20%, still more preferably at least 25%, especially at least 30%, more especially at least 40%, such as at least 50%, more preferably at least 65%. The relative humidity at the locus is preferably no greater than 98%, more preferably no greater than 95%. A relative humidity of from 30 to 95% is preferred for treatment of the locus with the sulphonylurea. A relative humidity of from 50 to 95% is particularly preferred for treatment of the locus with the sulphonylurea.

The method of the present invention may be employed in a wide range of different locations and at a range of different times during the year. Preferably, the location and/or the time of year are selected to provide the locus with the optimum number of hours of sunlight. In this respect, the locus preferably is experiencing at least 240 hours of sunlight per month, more preferably at least 245 hours, still more preferably at least 250 hours, more preferably still at least 255 hours, especially at least 260 hours of sunlight per month. The locus preferably experiences up to 340 hours of sunlight per month, more preferably up to 330 hours, still more preferably up to 320 hours, more preferably still up to 315 hours, especially up to 310 hours of sunlight per month. The number of hours of sunlight per month at the locus is preferably from 240 to 340, more preferably from 245 to 330, still more preferably from 250 to 320, more preferably still from 255 to 315. It is especially preferred that the locus experiences from 260 to 310 hours of sunlight per month at the time of treatment with the sulphonylurea.

The time period N days may be determined using the following formula (I):

$$N = 22.87 {e}^{\frac{1.71}{T}} - \frac{RH \% \times Y}{10.2} - \frac{HS \times Y}{151.8} - 1.79 , \qquad ( I )$$

where N is the time between the end of the treatment of the locus with the sulphonylurea and the planting or sowing of the crop plant (days);

T is the ambient or atmospheric temperature prevailing at the locus (Kelvin) at the time of the treatment:

RH is the relative humidity of the air at the locus (%) at the time of the treatment;

HS is the number of hours of sunlight at the locus at the time of treatment; and

Y is determined by the following formula (II):

$$Y = - ln ( ARw \times \frac{1}{ARv} \times 1 / 410.4 ) \qquad ( II )$$

where

AR_{w} is the weight application rate of the sulphonylurea to the locus (g/ha);

ARᵥ is the volumetric application rate of the sulphonylurea formulation to the locus (litres per hectare (1/ha)).

In the above formulae, the weight application rate of the sulphonylurea and the volumetric application rate of the sulphonylurea formulation are preferably selected such that the value of Y is at least 5, more preferably at least 5.5, still more preferably at least 6. Preferably the application rates AR_{w} and AR, are selected such that Y is no greater than 9, more preferably no greater than 8.5, still more preferably no greater than 8. Y is preferably from 5 to 9, more preferably from 5.5 to 8.5, especially from 6 to 8.

By selecting the application rates AR_{w} and ARᵥ to provide a value of Y in these ranges, the concentration of the sulphonylurea formulation is optimised, such that effective control of the target weeds, in particular glyphosate-resistant weeds, is obtained without the sulphonylurea persisting at the locus in sufficient amounts to cause significant damage to the crop plants when planted or sown.

The term

$${e}^{\frac{1.71}{T}}$$

is preferably at least 1.001, more preferably at least 1.004, still more preferably at least 1.005. The term

$${e}^{\frac{1.71}{T}}$$

is preferably no greater than 1.008, more preferably no greater than 1.007, still more preferably 1.0065. It is preferred that the method of the present invention is applied when the prevailing temperature conditions are such that

$${e}^{\frac{1.71}{T}}$$

is from 1.0054 to 1.0060.

The time period of N days is selected depending upon the prevailing conditions and the parameters of the treatment of the locus with the sulphonylurea formulation, in particular to provide effective control of the target weeds, especially glyphosate-resistant plants, such as sour grass, while still allowing the crop plants, such as soybean and corn, to be planted or sown without significant damage to the plants.

Preferably. N is at least 14 days, more preferably at least 15 days, still more preferably at least 16 days, more preferably still at least 17 days, especially at least 18 days. It is preferred that N is at least 19 days, especially at least 20 days. Preferably N is up to 28 days, more preferably up to 27 days, still more preferably up to 26 days, more preferably still up to 25 days. It is preferred that N is up to 24 days, more preferably up to 23 days, especially up to 22 days. N may be from 14 to 28 days, preferably from 15 to 27 days, more preferably from 16 to 26 days, still more preferably from 17 to 25 days, more preferably still from 18 to 24 days, in particular from 19 to 23 days, especially from 20 to 22 days. A period N of 20 days has been found to be particularly advantageous in many embodiments.

As noted above, it is preferred that the locus is treated with the sulphonylurea when the conditions prevailing at the locus are humid. However, the method of the present invention may be employed when the conditions at the locus are dry, that is a low humidity and no rainfall, for example during the dry season. In such conditions, it is preferred that the period of N days, described or determined as set out above, is increased. In particular, when the conditions prevailing at the locus are dry and there is no rainfall, the period of N days may be increased by up to 14 days, preferably up to 12 days, more preferably up to 10 days, still more preferably by up to 8 days. Under dry conditions, the period of N days may be increased by at least 2 days, preferably at least 4 days, more preferably at least 6 days. In the case of dry conditions, the period of N days may be increased by from 2 to 14 days, preferably from 4 to 12 days, more preferably from 6 to 10 days. In many cases, the period of N days is advantageously increased by 8 days.

In the method of the present invention, the sulphonylurea may be employed as the sole herbicidally active ingredient applied to the locus. More preferably, one or more further herbicidally active compounds are applied to the locus.

In one preferred embodiment, glyphosate is applied to the locus. Glyphosate may be applied to the locus at the same time as the locus is treated with the sulphonylurea. Alternatively or in addition, glyphosate may be applied to the locus before and/or after the treatment of the locus with the sulphonylurea.

In one particularly preferred embodiment, glyphosate is applied to the locus at the same time as the sulphonylurea is applied to the locus. Glyphosate and the sulphonylurea may be applied to the locus as a single formulation comprising both active compounds. Alternatively, glyphosate and the sulphonylurea may be applied to the locus separately, one after the other.

Preferably, a single formulation comprising both glyphosate and the sulphonylurea is applied to the locus.

Glyphosate may be applied to the locus at any suitable application rate to control the growth of unwanted plants. Glyphosate may be applied to the locus at a rate of at least 100 grams active ingredient per hectare (g a.i./ha), preferably a rate of at least 200 g a.i./ha, more preferably at least 300 g a.i./ha, still more preferably at least 400 g a.i./ha, more preferably still at least 500 g a.i./ha, especially at least 600 g a.i./ha, in particular at least 700 g a.i./ha. Application rates of at least 800 g a.i./ha are suitable for many treatments, preferably at least 900 g a.i./ha, more preferably at least 1000 g a.i./ha. Glyphosate may be applied to the locus at a rate of up to 3000 g a.i./ha, preferably a rate of up to 2750 g a.i./ha, more preferably up to 2500 g a.i./ha, still more preferably up to 2250 g a.i./ha, more preferably still at least 2000 g a.i./ha, especially up to 1800 g a.i./ha, in particular up to 1600 g a.i./ha. A rate of up to 1400 g a.i./ha is advantageous for many embodiments. Glyphosate may be applied to the locus at a rate in the range of from 100 to 3000 g a.i./ha, preferably from 200 to 2600 g a.i./ha, more preferably from 300 to 2300 g a.i./ha, still more preferably from 400 to 2000 g a.i./ha, more preferably still from 500 to 1800 g a.i./ha, especially from 600 to 1600 g a.i./ha, in particular from 700 to 1500 g a.i./ha. An application rate of from 800 to 1400 g a.i./ha is particularly advantageous for many embodiments, with a rate of from 900 to 1200 g a.i./ha particularly effective in a number of crops. An application rate of glyphosate of from 1000 to 1150 g a.i./ha is very effective in many embodiments.

As noted above, one or more further herbicidally active compounds may also be employed, together with the sulphonylurea, either without glyphosate or, more preferably, with glyphosate.

The or each further herbicidally active compound may be applied to the locus at the same time as the locus is treated with the sulphonylurea. Alternatively or in addition, the or each further herbicidally active compound may be applied to the locus before and/or after the treatment of the locus with the sulphonylurea.

In one particularly preferred embodiment, the one or more further herbicidally active compounds is applied to the locus at the same time as the sulphonylurea is applied to the locus. The one or more further herbicidally active compounds and the sulphonylurea may be applied to the locus as a single formulation comprising both active compounds.

Alternatively, the one or more herbicidally active compounds and the sulphonylurea may be applied to the locus separately, one after the other.

Examples of further herbicidally active compounds that may be employed in the method include phenoxyacetic herbicides, such as 2,4 D, dicarboximide herbicides, such as flumioxazin, and imidazolinone herbicides, such as imazethapyr.

In embodiments where two or more herbicides are employed to treat the locus, the two or more herbicides may be applied to the locus in any order or combination. In one embodiment, the two or more herbicides are applied to the locus simultaneously, for example by way of a single composition. Alternatively, the two or more herbicides may be applied to the locus separately, for example consecutively.

The active herbicide components may be applied to the locus in any suitable form, typically by way of a herbicidal composition.

In addition to the active herbicidal compounds, the composition may further contain one or more agriculturally acceptable auxiliaries. The auxiliaries employed in the composition and their amounts will depend upon the type of formulation and/or the manner in which the formulation is to be applied by the end user. Suitable auxiliaries are customary formulation adjuvant or components, such as dispersants, wetting agents, extender, carriers, solvents, surfactants, stabilizers, anti-foam agents, anti-freeze agents, preservatives, antioxidants, colorants, thickeners, solid adherents and inert fillers. Such auxiliaries are known in the art and are commercially available.

The composition may comprise one or more dispersants. Suitable dispersants are known in the art and are commercially available. Examples of suitable dispersants include, but are not limited to, Dispersogen®1494, sodium lignosulphonate, sulfonated aromatic polymer, sodium salt and fatty alcohol polyglycol ether.

The composition may comprise one or more wetting agents. Suitable wetting agents are known in the art and are commercially available. Examples of suitable wetting agents include, but are not limited to, sodium N-methyl-N-oleyl taurate, octylphenoxy polyethoxy ethanol, nonylphenoxy polyethoxy ethanol, sodium dioctyl sulfosuccinate, sodium dodecyl benzyl sulfonate, sodium lauryl sulfonate, sodium alkyl naphthalene sulfonate, sodium sulfonated alkyl carboxylate, and sodium alkyl naphthalene sulfonate.

The composition may comprise one or more solvents. The solvent may be organic or inorganic. Suitable solvents are selected from customary solvents which thoroughly dissolve the agrochemically active substances employed. Suitable solvents are known in the art and are commercially available. Examples of suitable solvents include water; aromatic solvents, such as xylene (for example solvent products commercially available from Solvesso®); mineral oils; animal oils; vegetable oils; alcohols, for example methanol, butanol, pentanol, and benzyl alcohol; ketones, for example cyclohexanone, and gamma-butyrolactone; pyrrolidones, such as NMP, and NOP; acetates, such as glycol diacetate; glycols; fatty acid dimethylamides; fatty acids; and fatty acid esters.

The composition may further comprise one or more surfactants. Suitable surfactants are known in the art and include, but are not limited to, alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, arylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose and ethylene oxide/propylene oxide block copolymers. Suitable surfactants are commercially available.

The composition may further comprise one or more polymeric stabilizers. Suitable polymeric stabilizers that may be used in the present invention include, but are not limited to, polypropylene, polyisobutylene, polyisoprene, copolymers of monoolefins and diolefins, polyacrylates, polystyrene, polyvinyl acetate, polyurethanes or polyamides. Suitable stabilizers are known in the art and are commercially available.

The composition may further comprise one or more anti-foam agents. Suitable anti-foam agents include those substances which can normally be used for this purpose in agrochemical compositions and will be readily apparent to the person skilled in the art. Suitable anti-foam agents are known in the art and are commercially available. Particularly preferred anti-foam agents are mixtures of polydimethylsiloxanes and perfluroalkylphosphonic acids, such as the silicone anti-foam agents (for example commercially available from GE or Crompton). Other examples of anti-foam agents are fatty acids, tallow, and sodium salts.

The composition may further comprise one or more preservatives. Suitable preservatives include those substances which can normally be used for this purpose in agrochemical compositions of this type and again are well known in the art. Suitable examples that may be mentioned include Preventol® (commercially available from Lanxess Corporation) and Proxel® (commercially available from Lonza Inc.).

The composition may further comprise one or more antioxidants. Suitable antioxidants are substances which can normally be used for this purpose in agrochemical compositions, as is known in the art. Preference is given, for example, to butylated hydroxytoluene.

The composition may further comprise one or more solid adherents. Such adherents are known in the art and available commercially. Suitable solid adherents include organic adhesives, including tackifiers, such as celluloses of substituted celluloses, natural and synthetic polymers in the form of powders, granules, or lattices, and inorganic adhesives such as gypsum, silica, or cement.

The composition may further comprise one or more inert fillers. Such inert fillers are known in the art and available commercially. Suitable fillers include, for example, natural ground minerals, such as kaolins, aluminas, talc, chalk, quartz, attapulgite, montmorillonite, and diatomaceous earth, or synthetic ground minerals, such as highly dispersed silicic acid, aluminium oxide, silicates, and calcium phosphates and calcium hydrogen phosphates. Suitable inert fillers for granules include, for example, crushed and fractionated natural minerals, such as calcite, marble, pumice, sepiolite, and dolomite, or synthetic granules of inorganic and organic ground materials, as well as granules of organic material, such as sawdust, coconut husks, corn cobs, and tobacco stalks. Examples of inert fillers also include sodium tripolyphosphate and sucrose.

The composition may further comprise one or more thickeners. Suitable thickeners include those substances which can normally be used for this purpose in agrochemical compositions. Examples of suitable thickeners include gums, such as xanthan gum, PVOH, cellulose and its derivatives, clay hydrated silicates, magnesium aluminium silicates or a mixture thereof. Again, such thickeners are known in the art and are available commercially.

The composition may be provided in the form of several different formulations, for example, a water-soluble concentrate (SL), an emulsifiable concentrate (EC), an emulsion (EW), a micro-emulsion (ME), a suspension concentrate (SC), an oil-based suspension concentrate (OD), a flowable suspension (FS), a water-dispersible granule (WG), water-soluble granule (SG), a water-dispersible powder (WP), a water soluble powder (SP), granules (GR), encapsulated granules (CG), fine granules (FG), macrogranules (GG), an aqueous suspo-emulsion (SE), a capsule suspension (CS) and microgranules (MG). In certain embodiments, the formulation of the herbicidal composition is in the form of water-dispersible granules (WG).

Depending upon the formulation, the composition may also comprise water.

Methods and techniques for applying the herbicidal composition to the locus are known in the art and will be understood by the person skilled in the art. Techniques include diluting or dispersing the composition in a suitable diluent or carrier liquid, in particular water, and applying the composition by spraying.

The method hereinbefore described may be employed as part of a regime for planting crops, in particular as part of a crop rotation regime at the locus. More particularly, the regime of treating the locus with the sulphonylurea and planting the crop susceptible to damage by the sulphonylurea N days after the said treatment may be preceded by the harvesting of a different crop from the locus and/or followed by harvesting the crop susceptible to damage by the sulphonylurea and planting of a different crop at the locus.

For example, in one embodiment, the method of the present invention comprises:

i) harvesting a first crop plant from the locus;

ii) applying a sulphonylurea herbicide to the locus; and

iii) planting a second crop plant at the locus a time N days after the application of the sulphonylurea in step ii); wherein the sulphonylurea is phytotoxic to the second crop plant.

The first crop may also be a crop that suffers from the phytotoxic effects of sulphonylurea herbicides.

In one preferred embodiment, one of the first and second crop plants is soybean and the other of the first and second crop plants is corn.

In one embodiment, the method of the present invention comprises:

i) harvesting corn plants from the locus;

ii) applying a sulphonylurea herbicide to the locus; and

iii) planting soybean plants at the locus a time N days after the application of the sulphonylurea herbicide in step ii).

In an alternative embodiment, the method of the present invention comprises:

i) harvesting soybean plants from the locus:

ii) applying a sulphonylurea herbicide to the locus; and

iii) planting corn plants at the locus a time N days after the application of the sulphonylurea herbicide in step ii).

In a further alternative embodiment, the method of the present invention comprises.

i) applying a sulphonylurea herbicide to the locus:

ii) planting soybean plants at the locus a time N days after the application of the sulphonylurea herbicide in step i);

iii) harvesting soybean plants from the locus; and

iv) planting and harvesting corn plants from the locus.

In the method of the present invention, the locus may be treated with a sulphonylurea herbicide after the crop has been planted at the locus, provided that the sulphonylurea herbicide is applied to the crop at a stage in the development of the crop plants when the phytotoxic effects of the sulphonylurea herbicide are at a minimum, preferably substantially zero. The use of such a further treatment with the sulphonylurea is dependent upon the level of resistance to sulphonylurea herbicides exhibited by the plant and the phytotoxic effects of the sulphonylurea herbicide on the crop plants. This embodiment may be employed with crop plants that exhibit a sufficient level of resistance to the phytotoxic effects of the sulphonylurea herbicide being used during at least one of the phases of growth of the plants. For example, in the case of soybean, it has been found that soybean plants in the vegetative phase of development are more resistant to the effects of sulphonylurea herbicides than in earlier stages of development, such that the soybean plants in the vegetative phase of development can withstand treatment with a sulphonylurea herbicide. In contrast, for example, corn plants exhibit a lower resistance to sulphonylurea herbicides. With plants, such as corn, the further treatment of the locus with the sulphonylurea herbicide is preferably omitted.

Therefore, in a further embodiment, the method of the present invention comprises:

i) applying a sulphonylurea to the locus;

ii) planting soybean plants at the locus a time N days after the application of the sulphonylurea herbicide in step i);

iii) applying a sulphonylurea herbicide to the locus during the period that the soybean plants are in the vegetative phase of development;

iv) harvesting soybean plants from the locus:

v) planting corn plants at the locus; and

vi) harvesting corn plants from the locus.

Crop plants may be planted at the locus as seedlings, having been germinated or propagated at another location. Alternatively, the crop plants may be planted at the locus as seeds and the seeds allowed to germinate.

In all cases, the crop plants planted at the locus are allowed to mature and are harvested in accordance with the normal growing and harvesting procedures of the plant in question. In this respect, references to ‘harvesting’ include references to harvesting all of the plant or harvesting parts of the plant, such as fruit, seeds, leaves, roots or the like. Aspects and embodiments of the present invention will be further described, for illustration only, by way of the following working examples.

Unless otherwise indicated, percentages are percentage by weight.

### EXAMPLES

### Example 1

Post-emergence treatment tests were conducted on glyphosate-resistant sourgrass (Digitaria insularis). Sourgrass plants were planted and kept in a greenhouse at about 24° C. and 85% humidity throughout the experiment.

The sourgrass plants were treated with water dispersible granule (WG) formulations of nicosulfuron summarised in Table 1. By way of comparison, Comparative Example 1 employed a formulation of clethodim at the application rate indicated in Table 1.

TABLE 1

| | Application |
|---|---|
| | rate of active |
| Formulation (WG) | compound (g/ha) |
| A1 (Nicosulfuron) | 52.5 |
| B1 (Nicosulfuron) | 60 |
| C1 (Nicosulfuron) | 67.5 |
| D1 (Nicosulfuron) | 75 |
| Comparative Example 1 | 96 |
| (Clethodim) | |
| Control 1 | 0 |

The WG formulations were each diluted with water prior to treatment of the sourgrass plants.

The herbicidal efficiency of each formulation as determined by visual observation at each of 7, 14 and 20 days after the treatment.

The the efficacy of each formulation is represented by a comparison between the treated plants and the Control plants. A score of 0% represents no herbicidal activity. A score of 100% represents complete herbicidal activity (plants completely killed).

The results are set out in Table 2 below.

TABLE 2

| | Sourgrass control (%) | | |
|---|---|---|---|
| Formulation | 7 days after | 14 days after | 20 days after |
| (WG) | treatment | treatment | treatment |
| A1 | 50.5 | 80.5 | 78.75 |
| B1 | 54.5 | 83.25 | 82.75 |
| C1 | 58.75 | 80.5 | 83 |
| D1 | 60.25 | 88.5 | 89 |
| Comparative | 40 | 76.25 | 65.75 |
| Example 1 | | | |
| Control 1 | 0 | 0 | 0 |

The data presented in Table 2 demonstrate that nicosulfuron is effective in the control of sourgrass plants.

### Example 2

Post-emergence treatment tests were conducted on glyphosate-resistant sourgrass (Digitaria insularis). Sourgrass plants were planted and kept in a greenhouse at about 24° C. and 85% humidity throughout the experiment.

The sourgrass plants were treated with water dispersible granule (WG) formulations of nicosulfuron and glyphosate summarised in Table 3. By way of comparison, Comparative Example 2 employed a formulation of clethodim and glyphosate, and Comparative Example 3 employed a formulation of glyphosate at the application rates indicated in Table 3.

TABLE 3

| Formulation (WG) | Application | Application |
|---|---|---|
| (Glyphosate and indicated | rate of active | rate of |
| active ingredient) | ingredient (g/ha) | Glyphosate (g/ha) |
| A2 (Nicosulfuron) | 52.5 | 1080 |
| B2 (Nicosulfuron) | 60 | 1080 |
| C2 (Nicosulfuron) | 67.5 | 1080 |
| D2 (Nicosulfuron) | 75 | 1080 |
| Comparative Example 2 | 96 | 1080 |
| (Clethodim) | | |
| Comparative Example 3 | 0 | 1080 |
| Control 2 | 0 | 0 |

The WG formulations were each diluted with water prior to treatment of the sourgrass plants.

The herbicidal efficiency of each formulation was determined by visual observation at each of 7, 14 and 20 days after the treatment.

The the efficacy of each formulation is represented by a comparison between the treated plants and the Control plants. A score of 0% represents no herbicidal activity. A score of 100% represents complete herbicidal activity (plants completely killed).

The results are set out in Table 4 below.

TABLE 4

| | Sourgrass control (%) | | |
|---|---|---|---|
| Formulation | 7 days after | 14 days after | 20 days after |
| (WG) | treatment | treatment | treatment |
| A2 | 57 | 87.5 | 86.25 |
| B2 | 60.5 | 90.75 | 90.75 |
| C2 | 62.75 | 87.75 | 91 |
| D2 | 66 | 95 | 97 |
| Comparative | 42.5 | 80.5 | 69.25 |
| Example 2 | | | |
| Comparative | 0 | 3.5 | 6.75 |
| Example 3 | | | |
| Control 2 | 0 | 0 | 0 |

The data presented in Table 4 demonstrate that the use of nicosulfuron in combination with glyphosate was effective in the control of the glyphosate resistant sourgrass plants.

### Example 3—Phytotoxicity Test

Sourgrass plants were planted and kept at about 24° C. and 85% humidity throughout the experiment.

The sourgrass plants were treated with water dispersible granule (WG) formulations of nicosulfuron and/or glyphosate as summarised in Table 5.

TABLE 5

| Formulation | Nicosulfuron | Glyphosate |
|---|---|---|
| (WG) | (g/ha) | (g/ha) |
| A3 | 50 | 0 |
| B3 | 50 | 1080 |
| C3 | 75 | 0 |
| D3 | 75 | 1080 |

Soybean seeds were sown separately in each of the treated plots 1 day, 7 days, 14 days, 20 days and 30 days after the treatment.

In order to quantify the damage caused to the soybean plants, visual analysis of phytotoxicity was conducted and recorded based on the scale proposed by the European Weed Research Council. The extent of damage on this scale varies from 1 to 9, where “1” represents absence of symptoms and “9” represents total plant destruction.

Evaluation was conducted 7 days, 14 days, 21 days and 28 days after emergence of the soybean plants.

The results are set out in Table 6 below.

TABLE 6

| Treatment | | | | | | |
|---|---|---|---|---|---|---|
| Nicosulfuron | Glyphosate | Phytotoxicity Level | | | | |
| (g/ha) | (g/ha) | 1 day | 7 days | 14 days | 20 days | 30 days |
| 50 | 0 | 4 | 3 | 2 | 1 | 1 |
| 50 | 1080 | 5 | 4 | 2 | 1 | 1 |
| 75 | 0 | 4 | 4 | 2 | 1 | 1 |
| 75 | 1080 | 5 | 4 | 2 | 1 | 1 |

It was observed that there was no damage to the soybean plants if soybean seeds were sown at least 20 days after treatment of the sourgrass plants with the herbicides.

### Example 4—Phytotoxicity Tests

Sourgrass plants were planted and kept at the conditions summarised in Table 7 below throughout the experiment:

TABLE 7

| | | | Hours under |
|---|---|---|---|
| | Temperature | Humidity | sunlight per |
| Conditions | (° C.) | (%) | day (hr) |
| X1 | 17 | 95 | 8.5 |
| X2 | 24 | 85 | 9 |
| X3 | 32 | 65 | 9.5 |
| X4 | 37 | 30 | 10 |

The sourgrass plants were treated with WG formulations containing nicosulfuron and/or glyphosate as summarised in Table 8 below.

TABLE 8

| Nicosulfuron | Glyphosate |
|---|---|
| (g/ha) | (g/ha) |
| 75 | 0 |
| 75 | 1080 |

The WG formulations were dispersed in water and applied to the locus of the sourgrass plants at a volumetric rate of 150 L/ha.

Soybean seeds were sown in a greenhouse in the treated plots 20 days after the treatment with the herbicide(s). The period of 20 days was determined by applying Formula I above to the parameters set out above. The calculations are summarised in Table 9 below.

TABLE 9

| | Treatment | | No. of days |
|---|---|---|---|
| | Nicosulfuron | Glyphosate | N determined |
| Conditions | (g/ha) | (g/ha) | using Formula I |
| X1 | 75 | 0 | 20.21 |
| X2 | 75 | 0 | 20.26 |
| X3 | 75 | 0 | 20.36 |
| X4 | 75 | 0 | 20.57 |

In order to quantify the damage caused to the soybean plants, visual analysis of phytotoxicity was conducted and recorded based on the scale proposed by the European Weed Research Council. The extent of damage on this scale varies from 1 to 9, where “1” represents absence of symptoms and “9” represents total plant destruction.

Evaluation was conducted 7 days after emergence of the soybean plants.

The results are set out in Table 10 below.

TABLE 10

| | Treatment | | |
|---|---|---|---|
| | Nicosulfuron | Glyphosate | Phytotoxicity |
| Conditions | (g/ha) | (g/ha) | Level |
| X1 | 75 | 0 | 1 |
| X2 | 75 | 0 | 1 |
| X3 | 75 | 0 | 1 |
| X4 | 75 | 0 | 1 |
| X1 | 75 | 1080 | 1 |
| X2 | 75 | 1080 | 1 |
| X3 | 75 | 1080 | 1 |
| X4 | 75 | 1080 | 1 |

The data in Table 10 demonstrate that the method of the present invention may be employed with plants at loci under a range of different atmospheric conditions.

1. A method for controlling the growth of unwanted plants in crop plants at a locus using a sulphonylurea herbicide, wherein the sulfonylurea herbicide exhibits phytotoxicity to the crop plants, the method comprising:
a). applying a sulphonylurea herbicide to the locus; and
b). planting the crop plants at the locus a time N days after the application of the sulphonylurea herbicide in step a).

2. The method according to claim 1, wherein the sulphonylurea herbicide is selected from amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, and mixtures thereof.

3. The method according to claim 2, wherein the sulphonylurea herbicide is nicosulfuron.

4. The method according to claim 1, wherein the crop plants are soybean plants or corn plants.

5. The method according to claim 1, wherein the unwanted plants are one or more glyphosate-resistant plants selected from Smooth pigweed (Amaranthus hybridus), Palmer amaranth (Amaranthus palmeri), Spiny amaranth (Amaranthus spinosus), Tall waterhemp (Amaranthus tuberculatus), Common ragweed (Ambrosia artemisiifolia), Giant ragweed (Ambrosia trifida), Hairy beggarticks (Bidens pilosa), Greater beggarticks (Bidens subalternans), Sweet summer grass (Brachiaria eruciformis), Birdsrape mustard (Brassica rapa), Rescuegrass (Bromus catharticus), Ripgut brome (Bromus diandrus), Red brome (Bromus rubens), Tall windmill grass (Chloris elata), Windmill grass (Chloris truncate), Feather fingergrass (Chloris virgate), Hairy fleabane (Conyza bonariensis), Horseweed (Conyza canadensis), Sumatran fleabane (Conyza sumatrensis), Gramilla mansa (Cynodon hirsutus), Sourgrass (Digitaria insularis), Junglerice (Echinochloa colonal), Goosegrass (Eleusine indica), Woody borreria (Hedyotis verticillata), Common sunflower (Helianthus annuus), Smooth barley (Hordeum murinum), Kochia (Kochia scoparia), Willow-leaved lettuce (Lactuca saligna), Prickly lettuce (Lactuca serriola), Tropical sprangletop (Juddsgrass) (Leptochloa virgate), Perennial ryegrass (Lolium perenne), Italian ryegrass (Lolium perenne), Rigid ryegrass (Lolium rigidum), Ragweed parthenium (Parthenium hysterophorus), Arrocillo (Paspalum paniculatum), Buckhorn plantain (Plantago lanceolata), Annual bluegrass (Poa annua), Wild radish (Raphanus raphanistrum), Russian thistle (Salsola tragus), Annual sowthistle (Sonchus oleraceus), Johnsongrass (Sorghum halepense), Coat buttons (Tridax procumbens), and Liverseedgrass (Urochloa panicoides).

6. The method according to claim 5, wherein the unwanted plants are glyphosate-resistant sourgrass (Digitaria insularis).

7. The method according to claim 1, wherein the locus is subjected to a burndown treatment during the period of N days.

8. The method according to claim 7, wherein the herbicide employed in the burndown treatment is glyphosate.

9. The method according to claim 1, wherein the period of N days is determined using the following formula (I):
$$N = 22.87 {e}^{\frac{1.71}{T}} - \frac{RH \% \times Y}{10.2} - \frac{HS \times Y}{151.8} - 1.79 \qquad ( I )$$
where N is the time between the end of the treatment of the locus with the sulphonylurea and the planting or sowing of the crop plant (days);
T is the ambient or atmospheric temperature prevailing at the locus (Kelvin) at the time of treatment;
RH is the relative humidity of the air at the locus (%) at the time of treatment;
HS is the number of hours of sunlight at the locus at the time of treatment; and
Y is determined by the following formula (II):
$$Y = - ln ( ARw \times \frac{1}{ARv} \times 1 / 410.4 ) \qquad ( II )$$
where
AR_{w} is the weight application rate of the sulphonylurea to the locus (g/ha);
ARᵥ is the volumetric application rate of the sulphonylurea formulation to the locus (litres per hectare (l/ha)).

10. The method according to claim 9, wherein T is at least 285 K.

11. The method according to claim 9, wherein RH is at least 20%.

12. The method according to claim 9, wherein HS is at least 250 hours.

13. The method according to claim 9, wherein Y is at least 5.

14. The method according to claim 1, wherein N is from 18 to 24 days.

15. The method according to claim 14, wherein N is 20 days.

16. The method according to claim 1, wherein, if the conditions prevailing at the locus at the time of the treatment are dry, step (b) is carried out N+6 to 10 days after step (a).

17. The method according to claim 1, wherein in step (a) one or more further herbicidally active compounds are applied to the locus.

18. The method according to claim 17, wherein the further herbicidally active compound is glyphosate.

19. The method according to claim 1, the method comprising harvesting first crop plants from the locus before step (a).

20. The method according to claim 19, wherein the first crop plants are corn plants and the crop plants planted in step (b) are soybean plants, or wherein the first crop plants are soybean plants and the crop plants planted in step (b) are corn plants.

21. The method according to claim 1, wherein after step (b) the locus is subjected to a further treatment with a sulphonylurea herbicide during a phase of growth of the crop plants when the phytoxic effects of the sulphonylurea herbicide on the crop plants are sufficiently low.
